(19) United States
(12) Patent Application Publication
(10) Pub. No.: US 2022/0415535 A1
(43) Pub. Date: Dec. 29, 2022

(54) DIELECTRIC FLUID FOR TRANSFORMER RETROFILLING

(71) Applicant: ARKEMA FRANCE, Colombes (FR)

(72) Inventors: Jeremie WALKER, PIERRE-BENITE CEDEX (FR); Bernard MONGUILLON, COLOMBES CEDEX (FR)

(21) Appl. No.: 17/765,018

(22) PCT Filed: Sep. 18, 2020
(86) PCT No.: PCT/FR2020/051621

§ 371 Date: Mar. 30, 2022

(30) Foreign Application Priority Data
Oct. 1, 2019 (FR) 1910863

(51) Int. Cl. H01B 3/22; H01F 27/32; C09K 5/10

(52) U.S. Cl. CPC H01B 3/22; H01F 27/321; C09K 5/10

(57) ABSTRACT

The present invention relates to the use, for the retrofilling of a transformer, of at least one dielectric fluid of general formula (1):

(A−X)ₙ−B (1)

in which A and B, which are identical or different, represent, independently of each other, an optionally substituted aromatic ring, X represents a spacer group and n represents 0, 1, 2 or 3.

The invention also relates to a transformer containing at least one dielectric fluid of general formula (1) and an amount of PCBs of less than 20%.

The present invention relates to the field of electrical transformers and the dielectric fluids which contain them. These dielectric fluids can lose their effectiveness over time and under numerous stresses due to variations in temperature and electrical voltages. The transformer then loses in effectiveness and in yield, and can in some cases develop electrical or thermal faults.

The cost of replacing a transformer as new is often too high, and it is generally much more economical to consider a retrofilling operation which consists in operating the replacement, in whole or at the very least in part, of the spent dielectric fluids present in the transformers by new dielectric fluids, that is to say nonspent dielectric fluids, i.e. fluids not having already been used as dielectric fluid, or else having undergone one or more recycling stages.

More precisely, the retrofilling of a transformer is an operation which consists in emptying, in whole or at the very least in part, and most often in whole, the transformer of its dielectric fluid and replacing it with a fresh nonspent dielectric fluid.

The retrofilling operation can present certain difficulties, in particular due to the nature and the quality of the spent dielectric fluid which it is desired to replace. This is because the spent dielectric fluid can be more or less viscous and consequently difficult to extract from the transformer, which generally contains various parts made of wood, cardboard and/or paper and which are more or less impregnated with said dielectric fluid.

In addition, some transformers are equipped with dielectric fluids comprising more or less significant proportions of toxic and/or harmful compounds, such as, for example, PolyChloroBiphenyls, better known under their acronym “PCBs”, and also called PolyChlorinated Biphenyls or PCBs, or also sometimes “pyralenes” or also askarels, askarels being PCB compounds, with or without addition of polychlorobenzenes.

These PCBs are now increasingly banned by the various regulations in force throughout the world and it is now increasingly required to use dielectric fluids with a biodegradability of the order of 40% in 28 days according to the OECD 301 standard, for obvious reasons of environmental protection.

Thus, one of the possible solutions for eliminating the PCBs contained in transformers consists in carrying out a retrofilling operation, which operation is generally carried out today by replacing the spent dielectric fluid with a mineral oil.

However, this solution suffers from a drawback, in particular when the transformer contains a PCB and when the retrofilling is carried out with a mineral oil. This is because there is only a slight chemical affinity between mineral oils and PCBs, so that the emptying of the spent dielectric fluid is rarely complete or else requires numerous rinsings in order to bring the content of PCBs to values as low as possible, and in particular below the threshold recommended by the Stockholm Convention, i.e. below 50 ppm.

This is because transformers generally consist of a container in which the dielectric fluid is confined, said container being separated into various compartments and containing elements made of wood, cardboard or paper. These elements made of wood, cardboard or paper absorb a greater or lesser amount of dielectric fluid. For a replacement of the spent dielectric fluid by another nonspent dielectric fluid which is effective, rapid in time and as complete as possible, it is easily understood that it is necessary to be able to desorb effectively, rapidly in time and as completely as possible the spent fluid absorbed by the elements made of wood, cardboard or paper.

A dielectric fluid suitable for retrofilling operations must consequently and in particular be capable of effectively, rapidly in time and as completely as possible replacing the spent dielectric fluid, and in particular the spent dielectric fluid absorbed by the elements made of wood, cardboard or paper contained in the transformer.

In addition, the dielectric fluid suitable for retrofilling must, of course, exhibit all the characteristics required for optimum efficiency in any type of transformer, such as, for example, a transformer referred to as power or distribution or traction transformer, and preferably power or distribution transformer.

In point of fact, due to an increasingly great demand for energy, mainly in emerging countries, and due in particular to the electrification of countries experiencing economic growth, the market for dielectric fluids for transformers is continually growing.

Some manufacturers now offer, for retrofilling operations, natural or synthetic vegetable oils known in particular for their high biodegradability. However, these oils often have viscosity problems, especially when cold, and dielectric characteristics which are inadequate and very often far inferior to those of the spent dielectric fluids to be replaced.

In addition, the thermal properties, and thus the heat exchanges, are poorer than those of known dielectric fluids, so that vegetable oils are only rarely used today for retrofilling operations.

Forecasts of need for amount of electricity are constantly growing, and retrofilling is an option of choice making it possible to envisage the recycling of transformers rather than their scrapping and destruction. There thus remains today an urgent need for dielectric fluids which can be used in transformers and which are suitable for retrofilling operations, and in particular for operations for replacing dielectric fluids comprising a PCB. The present invention makes it possible in particular to solve, in whole or at the very least in part, the problems set out above.

This is because the inventors have now discovered that it is possible to use certain dielectric fluids for operations of retrofilling of transformers, and in particular of retrofilling of transformers loaded with PCBs or containing more or less significant amounts of PCBs as mixtures with one or more other dielectric fluid(s).

Thus, and according to a first aspect, the present invention relates to the use, for the retrofilling of a transformer, of at least one dielectric fluid of general formula (1):

(A−X)ₙ−B (1)

in which:

A and B, which are identical or different, represent, independently of each other, an aromatic ring optionally substituted by one or more saturated or partially or completely unsaturated hydrocarbon radicals comprising from 1 to 20 carbon atoms, preferably from 1 to 18 carbon atoms, more preferably from 1 to 12 carbon atoms, better still from 1 to 10 carbon atoms, even better still from 1 to 6 carbon atoms, typically from 1 to 3 carbon atoms,

X represents a spacer group chosen from a single bond, —O—, —S—, —(CRR′)ₘ—and —NR″—R and R′, which are identical or different, are chosen, independently of each other, from hydrogen and a saturated or partially or completely unsaturated hydrocarbon radical comprising from 1 to 6 carbon atoms, preferably from 1 to 3 carbon atoms,

R″ represents a saturated or partially or completely unsaturated hydrocarbon radical comprising from 1 to 6 carbon atoms, preferably from 1 to 3 carbon atoms,

m represents an integer of between 1 and 4, limits included, and

n can be equal to 0 or represents an integer equal to 1, 2 or 3, preferably equal to 1 or 2, with the restriction that, when n is equal to 0, B is substituted by one or more hydrocarbon radicals, as defined above.

The term “aromatic ring” is understood to mean aromatic hydrocarbon monocycles and aromatic hydrocarbon polycycles, comprising from 6 to 20 carbon atoms. The term “polycycle” is understood to mean fused or condensed rings, at least one ring of which is aromatic, it being possible for the other ring(s) to be partially or completely unsaturated.

When n is equal to 0, the dielectric fluid of formula (1) defined above belongs to the family of the alkylbenzenes and preferably meets the specifications defined in the standard IEC 60867, edition 2 of 1993. When n is equal to 2 or 3, the (A−X) groups can be identical or different.

The dielectric fluids of formula (1) defined above are known and available or else can be easily prepared from procedures known in the patent literature, the scientific literature or on the Internet. Examples of dielectric fluids of formula (1) above are in particular described in the patents or patent applications EP 0 444 989, U.S. Pat. No. 5,017,733, EP 2 720 232, US2009103239 and U.S. Pat. No. 4,618,914, to mention only a few of them, by way of nonlimiting examples.

According to a preferred embodiment of the present invention, in the dielectric fluid of general formula (1), n is different from 0 and B is an aromatic ring substituted by a hydrocarbon radical. Preferably again, said hydrocarbon radical is an alkyl radical comprising from 1 to 6 carbon atoms, preferably from 1 to 4 carbon atoms, and preferably the alkyl radical is the methyl radical.

According to another preferred embodiment of the present invention, in the dielectric fluid of general formula (1), n is equal to 0 and the dielectric fluid of formula (1) is generally chosen from linear alkylbenzenes and branched alkylbenzenes, such as, for example and in a nonlimiting way, alkylbenzenes in which the alkyl part comprises from 10 to 20 carbon atoms. Such alkylbenzenes comprise, still in a nonlimiting way, decylbenzene, dodecylbenzene and octadecylbenzene, to mention only a few of them.

All the dielectric fluids corresponding to the general formula (1) above can be used, alone or as mixtures of two or more of them in all proportions. In one embodiment, the use according to the present invention employs at least one dielectric fluid of formula (1) defined above, alone or as a mixture with one or more other dielectric fluids known to a person skilled in the art, such as, for example and without limitation, dielectric fluids chosen from mineral oils, vegetable oils and natural or synthetic esters.

The amount of dielectric fluid(s) according to the general formula (1) with respect to the totality of all of the dielectric fluids which can be used for the requirements of the present invention can vary within large proportions. It is, however, preferred to use the dielectric fluids according to the general formula (1) defined above in proportions of between 50% and 100% by weight, limits included, preferably between 70% and 100% by weight, limits included, with respect to the totality of all of the dielectric fluids which can be used for the requirements of the present invention.

According to yet another preferred embodiment of the present invention, the dielectric fluid is chosen from benzyltoluene (BT), dibenzyltoluene (DBT) and their mixtures in all proportions. The preferred BT/DBT mixtures are those comprising between 1% and 50%, limits included, by weight of benzyltoluene and more preferably between 15% and 30%, limits included, by weight of dibenzyltoluene, with respect to the total amount of benzyltoluene/dibenzyltoluene.

In a very particularly preferred embodiment, the dielectric fluid is chosen from the dielectric fluids sold by Arkema under the brand names of the Jarylec® range.

Other dielectric fluids suitable for the requirements of the present invention are those sold by Yantai Jinzheng, for example under the brand name SRS-401T, those sold by Jinzhou Yongia, such as, for example, M/DBT, and those sold by JX Nippon under the brand name SAS-60E.

Mention may be made, as other examples of dielectric fluids suitable for the requirements of the present invention, of:

diphenylethane (DPE) and its isomers, especially 1,1-DPE (CAS 612-00-0), 1,2-DPE (CAS 103-29-7) and their mixtures (in particular CAS 38888-98-1); such fluids are available commercially or described in the literature, for example in EP 0 098 677,

ditolyl ether (DT) and its isomers, especially those corresponding to the numbers CAS 4731-34-4 and CAS 28299-41-4 and their mixtures, these being in particular commercially available from Lanxess, under the brand name DiphylDT,

phenylxylylethane (PXE) and its isomers, especially those corresponding to the numbers CAS 6196-95-8 and CAS 76090-67-0 and their mixtures, in particular commercially available from Changzhou Winschem, under the brand name PXE Oil,

1,2,3,4-tetrahydro-(1-phenylethyl)naphthalene (CAS 63674-30-6), this product being commercially available in particular from Dow under the reference Dowtherm™ RP,

diisopropylnaphthalene (CAS 38640-62-9), available in particular from Indus Chemie Ltd under the brand name KMC 113,

monoisopropylbiphenyl and its isomers (CAS 25640-78-2), in particular available under the brand name Wemcol, and

phenylethylphenylethane (PEPE) and its isomers (CAS 6196-94-7), in particular available from Changzhou Winschem or Yantai Jinzheng, to mention only the main dielectric fluids known and usable in the context of the present invention.

Within the meaning of the present invention, a “transformer” can be any type of electrical transformer known to a person skilled in the art, and in particular any type of transformer referred to as distribution or power or traction transformer, preferably distribution or power transformer.

The dielectric fluid which can be used in the context of the present invention can in addition contain one or more additives well known to a person skilled in the art specializing in transformers and for example chosen from antioxidants, passivators, pour point depressants, decomposition inhibitors and their mixtures. A dielectric fluid which is very particularly preferred comprises a decomposition inhibitor.

Mention may be made, among the antioxidants which can be advantageously used in the dielectric fluid, as nonlimiting examples, of phenolic antioxidants, such as, for example, butylated hydroxytoluene, butylated hydroxyanisole, tocopherols, as well as the acetates of these phenolic antioxidants; but also antioxidants of amine type, such as, for example, phenyl-α-naphthylamine, of diamine type, for example N,N′-di(2-naphthyl)-para-phenylenediamine, but also ascorbic acid and its salts, esters of ascorbic acid, alone or as mixtures of two or more of them or with other components, such as, for example, green tea extracts or coffee extracts.

A very particularly suitable antioxidant is that commercially available from Brenntag under the trade name lonol®.

The passivators which can be used as additives in the dielectric fluid which can be used in the context of the present invention are of any type known to a person skilled in the art and are advantageously chosen from triazole derivatives, benzimidazoles, imidazoles, thiazole or benzothiazole. Mention may be made, by way of example and in a nonlimiting way, of dioctylaminomethyl-2,3-benzotriazole and 2-dodecyldithio-imidazole.

Mention may be made, among the pour point depressants which can be present in the dielectric fluid which can be used in the context of the present invention, as nonlimiting examples, of sucrose fatty acid esters or acrylic polymers, such as poly(alkyl methacrylate) or poly(alkyl acrylate).

The preferred acrylic polymers are those, the molecular weight of which is between 50 000 g mol⁻¹ and 500 000 g mol⁻¹. Examples of these acrylic polymers include polymers which can contain linear alkyl groups comprising from 1 to 20 carbon atoms.

Mention may be made, among these and still as nonlimiting examples, of poly(methyl acrylate), poly(methyl methacrylate), poly(heptyl acrylate), poly(heptyl methacrylate), poly(nonyl acrylate), poly(nonyl methacrylate), poly(undecyl acrylate), poly(undecyl methacrylate), poly(tridecyl acrylate), poly(tridecyl methacrylate), poly(pentadecyl acrylate), poly(pentadecyl methacrylate), poly(heptadecyl acrylate) and poly(heptadecyl methacrylate).

An example of such a pour point depressant is commercially available from Sanyo Chemical Industries Ltd under the brand name Aclube.

According to a very particularly preferred aspect, the dielectric fluid which can be used in the context of the present invention comprises at least one decomposition inhibitor as additive. The decomposition inhibitor can be of any type well known to a person skilled in the art and in particular can be chosen from carbodiimide derivatives, such as diphenylcarbodiimide, ditolylcarbodiimide, bis(isopropylphenyl)carbodiimide or bis(butylphenyl)carbodiimide, but also from phenyl glycidyl ethers, or esters, alkyl glycidyl ethers, or esters, 3,4-epoxycyclohexylmethyl 3,4-epoxycyclohexanecarboxylate, compounds of the anthraquinone family, such as, for example, β-methylanthraquinone sold under the name “BMAQ”, epoxy derivatives, such as vinylcyclohexene diepoxides, 3,4-epoxy-6-methylcyclohexylmethyl 3,4-epoxy-6-methylhexanecarboxylate, epoxy resins of phenol novolak type, bisphenol A diglycidyl ether epoxys, such as BADGE, or CEL 2021P, available in particular from Whyte Chemical.

According to a specific embodiment of the invention, the dielectric fluid which can be used in the context of the present invention comprises at least one decomposition inhibitor.

The content by weight of the additive or additives optionally present in the dielectric fluid which can be used in the context of the present invention can range from 0.0001% to 2% by weight, preferably from 0.001% to 1% by weight and more preferably from 0.01% to 1% by weight, limits included, with respect to the total weight of the mixture.

The dielectric fluid of general formula (1) is a fluid very particularly suitable for the “retrofilling” operations as defined above. This is because, and without wishing to be committed to the theory, its aromatic structure confers on it a good, indeed even a very good, chemical affinity with the spent dielectric fluid already present in the transformer and in particular when the dielectric fluid comprises one (or more) aromatic dielectric fluid(s), such as, for example, a PCB.

Because of this good affinity, the spent dielectric fluid already present in the transformer will migrate more easily from the paper and/or cardboard and/or wood to the dielectric fluid of general formula (1), this being the case from the first retrofilling charge.

The migration time depends on numerous factors and in particular on the structure and on the size of the transformer, on its volume but also and above all on the nature and on the viscosity of the dielectric fluid contained, and can consequently sometimes require several retrofilling operations and this over a more or less lengthy period.

The dielectric fluids of formula (1) defined above and very particularly the dielectric fluids of the Jarylec® range from Arkema generally exhibit a lower viscosity, at ambient temperature (i.e. approximately 25° C.), than a mineral oil. With a lower viscosity, the dielectric fluid of formula (1) is thus much more fluid and consequently the diffusion time of the spent dielectric fluid will be all the shorter.

The dielectric fluid of general formula (1) as defined above is thus very particularly suitable for carrying out an operation of retrofilling of a transformer containing a spent dielectric fluid. The dielectric fluid of general formula (1) is in particular very particularly suitable for carrying out an operation of retrofilling of a transformer containing a PCB-based dielectric fluid, but also having contained a PCB-based dielectric fluid and which has already formed the subject of an operation of retrofilling by a mineral oil. This is because the dielectric fluid of formula (1) defined above exhibits not only a good affinity with dielectric mineral oils but also and particularly a very good affinity with PCBs.

The use of a dielectric fluid according to the general formula (1) to carry out a retrofilling operation can consequently prove to be entirely suitable for further reducing the PCB residues present in transformers and in particular in transformers having already undergone a retrofilling operation, in particular an operation of retrofilling with a dielectric mineral oil.

The term “affinity” means that the fluid which is endowed with it is compatible, that is to say miscible (i.e. a single phase), in the proportions and temperatures of use.

One of the advantages of the use according to the present invention is thus to make possible rapid and effective decontamination of a transformer containing PCB. Thus, the dielectric fluids of general formula (1) as defined above are very particularly suitable for the recommissioning of transformers previously loaded with PCBs, thus resulting in transformers which are now more environmentally friendly.

Thus, the use according to the present invention makes it possible to have available, on the market, transformers whose performance qualities are entirely similar to those of transformers containing PCBs but better than those of transformers containing a mineral oil, while complying with the regulations in force, that is to say with a very low concentration of PCBs, indeed even a complete absence of PCBs.

According to another aspect, the present invention relates to a process for the retrofilling of a transformer, said process comprising at least the following stages:

a) providing a transformer comprising a first dielectric fluid,
b) emptying said first dielectric fluid,
c) optionally placing the transformer under vacuum,
d) filling with a dielectric fluid of general formula (1) as defined above,
e) optionally repeating stages b) to d), until an amount of said first dielectric fluid of less than 20%, preferably of less than 10%, more preferably of less than 10%, more preferably of less than 1%, typically of less than 0.1%, more particularly of less than 0.01%, by volume, limits included, with respect to the total volume of the dielectric fluid present in the transformer, is obtained, and
f) recovering the transformer containing the dielectric fluid used in stage d), and in which the content of first dielectric fluid is respectively less than 20%, preferably less than 10%, more preferably less than 10%, more preferably less than 1%, typically less than 0.1%, more particularly less than 0.01%, by volume, limits included, with respect to the total volume of the dielectric fluid present in the transformer.

The term “emptying” is understood to mean the discharge by flow, generally by flow by gravity, of the fluid. This discharge by flow is carried out for a more or less lengthy period, depending on the structure, the nature and the size of the transformer and on the amount and the viscosity of the fluid to be emptied. This period is generally between a few minutes and a few hours. After this emptying, discharge is in addition generally left to take place dropwise, by gravity, for an additional period of 1 to a few hours, for example approximately 2 hours.

The filling of the transformer described in stage d) above can be carried out according to any method well known to a person skilled in the art. Generally but not obligatorily, the filling is carried out under more or less high vacuum. According to an advantageous embodiment of the invention, the transformer is placed under vacuum, according to any means known to a person skilled in the art. When the vacuum is stabilized, the filling is then carried out under this reduced pressure.

This filling consists in particular in introducing, generally slowly (in particular in order to avoid the trapping of air bubbles), the necessary amount of nonspent dielectric fluid into the transformer. The term “necessary amount” is understood to mean a necessary and sufficient amount well known to a person skilled in the art, generally in order to completely fill said transformer, for example until said transformer overflows but also and preferably until reaching the level of the conservator, or expansion vessel, for providing for the overflow of the dielectric fluid when the transformer is fully loaded with a rise in temperature which can bring about the expansion of said dielectric fluid.

On conclusion of the retrofilling operation, a transformer containing a predominant amount of nonspent dielectric fluid is recovered. Such a transformer comprising a predominant amount of dielectric fluid of general formula (1) as defined above and optionally an amount of first dielectric fluid of less than 20%, preferably of less than 10%, more preferably of less than 10%, more preferably of less than 1%, typically of less than 0.1%, more particularly of less than 0.01%, by volume, limits included, with respect to the total volume of dielectric fluid present in said transformer, also comes within the present invention.

By virtue of the use of a fluid of general formula (1) for the operation of retrofilling of a transformer, in particular of a transformer loaded with PCBs, the transformer thus regenerated exhibits a very low content of residual PCBs. In addition, this low content is retained over time, thus showing the great advantage of retrofilling with a dielectric fluid of general formula (1).

Throughout the present description, the quantitative determination of PCBs is carried out by Gas-Liquid Chromatography/Electron Capture Detection, as described for example in the document “Guidelines for the Identification of PCBs and Materials Containing PCBs, First Issue”, August 1999, published by the United Nations Environment Programme (UNEP).

According to a preferred embodiment, the invention relates, for example, to a transformer comprising a dielectric fluid of general formula (1) as defined above and optionally an amount of PCBs of less than 20%, preferably of less than 10%, more preferably of less than 10%, more preferably of less than 1%, typically of less than 0.1%, more particularly of less than 0.01%, by volume, limits included, with respect to the total volume of dielectric fluid present in said transformer.

According again to a preferred embodiment, the invention relates to a transformer comprising at least one dielectric fluid of general formula (1), preferably a BT/DBT mixture, and an amount of PCBs of less than 20%, preferably of less than 10%, more preferably of less than 10%, more preferably of less than 1%, typically of less than 0.1%, more particularly of less than 0.01%, by volume, limits included, with respect to the total volume of dielectric fluid present in said transformer.

The following examples make it possible to obtain a better understanding of the invention and are presented by way of illustration, without however limiting in any way whatsoever the scope of protection requested and defined by the claims appended to the present description.

### EXAMPLE

### Retrofilling of a Transformer Containing a PCB/Trichlorobenzene Mixture

A transformer containing a 60/40 by weight mixture of PCBs and trichlorobenzene is subjected to a retrofilling operation with a dielectric fluid which is a BT/DBT mixture sold by Arkema under the Jarylec® name.

A series of 4 retrofilling operations is carried out, each operation being carried out 3 months after the preceding one. Before each operation, the residual PCB is quantitatively determined. The results are presented in the following table 1.

TABLE 1

| Time (months) | Content of PCBs |
|---|---|
| 0 | 60% |
| 3 | 5.5% |
| 6 | 0.51% |
| 9 | 0.04% |
| 12 | <<50 ppm |

As indicated above, the retrofilling operations are carried out every three months, each measurement of residual contents of PCBs being carried out just before the retrofilling operation. Between the different retrofilling operations, the transformer is placed under voltage.

This example shows that the threshold of 50 ppm is reached after the 4th retrofilling operation. This threshold is reached in lasting fashion, whereas, with several retrofilling operations with a mineral oil, this threshold of 50 ppm, once reached, is not stable and it is not uncommon to observe an increase in the content of PCBs. It is then necessary to carry out one, indeed even several, additional retrofilling operation(s). It has also been found that this instability can last for very many years when the retrofilling is carried out with a mineral oil.

The great advantage of using a dielectric fluid of formula (1), as defined above, for the retrofilling operations, in particular for the retrofilling of transformers containing or having contained a PCB, is thus demonstrated.

1-10. (canceled)

11. A dielectric fluid for the retrofilling of a transformer, the fluid having a general formula (1):
(A−X)ₙ−B (1)
wherein:
A and B, which are identical or different, represent, independently of each other, an aromatic ring optionally substituted by one or more saturated or partially or completely unsaturated hydrocarbon radicals comprising from 1 to 20 carbon atoms,
X represents a spacer group chosen from a single bond, —O—, —S—, —(CRR′)ₘ—and —NR″—,—
R and R′, which are identical or different, are chosen, independently of each other, from hydrogen and a saturated or partially or completely unsaturated hydrocarbon radical comprising from 1 to 6 carbon atoms,
R″ represents a saturated or partially or completely unsaturated hydrocarbon radical comprising from 1 to 6 carbon atoms,
m represents an integer of between 1 and 4, limits included, and
n can be equal to 0 or represents an integer equal to 1, 2 or 3, with the restriction that, when n is equal to 0, B is substituted by one or more hydrocarbon radicals, as defined above.

12. The dielectric fluid as claimed in claim 11, wherein, in the dielectric fluid of general formula (1), n is different from 0 and B is an aromatic ring substituted by a hydrocarbon radical.

13. The dielectric fluid as claimed in claim 11, wherein, in the dielectric fluid of general formula (1), n is different from 0 and B is an aromatic ring substituted by an alkyl radical comprising from 1 to 6 carbon atoms.

14. The dielectric fluid as claimed in claim 11, wherein the dielectric fluid is selected from the group consisting of benzyltoluene, dibenzyltoluene and their mixtures in all proportions.

15. The dielectric fluid as claimed in claim 11, wherein the dielectric fluid is a benzyltoluene/dibenzyltoluene mixture comprising between 1% and 50%, limits included, by weight of dibenzyltoluene, with respect to the total amount of benzyltoluene/dibenzyltoluene.

16. The dielectric fluid as claimed in claim 11, wherein the dielectric fluid in addition contains one or more additives selected from the group consisting of antioxidants, passivators, pour point depressants, decomposition inhibitors and their mixtures.

17. The dielectric fluid as claimed in claim 11, wherein the dielectric fluid comprises at least one decomposition inhibitor selected from the group consisting of carbodiimide derivatives, phenyl glycidyl ethers, or esters, alkyl glycidyl ethers, or esters, 3,4-epoxycyclohexylmethyl 3,4-epoxycyclohexanecarboxylate, compounds of the anthraquinone family, epoxy derivatives, 3,4-epoxy-6-methylcyclohexylmethyl 3,4-epoxy-6-methylhexanecarboxylate, and epoxy resins of phenol novolak type or bisphenol A diglycidyl ether epoxys.

18. A process for the retrofilling of a transformer, said process comprising at least the following stages:
a) providing a transformer comprising a first dielectric fluid,
b) emptying said first dielectric fluid,
c) optionally placing the transformer under vacuum,
d) filling with a dielectric fluid of general formula (1) as defined in claim 11, e) optionally repeating stages b) to d), until an amount of said first dielectric fluid of less than 20%, by volume, limits included, with respect to the total volume of the dielectric fluid present in the transformer, is obtained, and
f) recovering the transformer containing the dielectric fluid used in stage d), and wherein the content of first dielectric fluid is respectively less than 20%, by volume, limits included, with respect to the total volume of the dielectric fluid present in the transformer.

19. A transformer comprising at least one dielectric fluid of general formula (1) defined in claim 11 and an amount of PolyChloroBiphenyls (PCBs) of less than 20%, by volume, limits included, with respect to the total volume of dielectric fluid present in said transformer.

20. The transformer as claimed in claim 19, wherein the dielectric fluid of general formula (1) is a benzyltoluene/dibenzyltoluene mixture.
